(19) United States
(12) Patent Application Publication
(10) Pub. No.: US 2024/0233706 A1
(43) Pub. Date: Jul. 11, 2024

(54) TEXT-BASED SPEECH GENERATION

(71) Applicant: Microsoft Technology Licensing, LLC, Redmond, WA (US)

(72) Inventors: Xu TAN, Redmond, WA (US); Tao Qin, Beijing (CN); Sheng Zhao, Redmond, WA (US); Tie-Yan Liu, Beijing (CN)

(21) Appl. No.: 18/562,962

(22) PCT Filed: May 23, 2022
(86) PCT No.: PCT/US2022/030458

§ 371 Date: Nov. 21, 2023

(30) Foreign Application Priority Data
Jun. 28, 2021 (CN) 202110721773.9

(51) Int. Cl. G10L 13/10; G10L 13/047; G10L 13/06

(52) U.S. Cl. CPC G10L 13/10; G10L 13/047; G10L 13/06; G10L 2013/105

(57) ABSTRACT

According to implementations of the subject matter described herein, a solution is proposed for text to speech. In this solution, an initial phoneme sequence corresponding to text is generated, the initial phoneme sequence comprising feature representations of a plurality of phonemes. A first phoneme sequence is generated by inserting a feature representation of an additional phoneme into the initial phoneme sequence, the additional phoneme being related to a characteristic of spontaneous speech. The duration of a phoneme among the plurality of phonemes and the additional phoneme is determined by using an expert model corresponding to the phoneme, and a second phoneme sequence is generated based on the first phoneme sequence. Spontaneous-style speech corresponding to the text is determined based on the second phoneme sequence. In this way, spontaneous-style speech with more varying rhythms can be generated based on spontaneous-style additional phonemes and multiple expert models.

### BACKGROUND

Text-based speech generation is also referred to as text to speech (TTS). TTS is used to convert text into speech outputs. TTS is one of speech synthesis applications and plays an important role in reading assistance, voice prompts and the like. However, there is a gap between the speech generated by TTS and spontaneous speech. For example, the generated speech is stiffer and less smooth than the spontaneous speech. Therefore, a method of generating spontaneous-style speech based on text is in demand.

### SUMMARY

According to implementations of the subject matter described herein, there is provided a solution for text-based speech generation. In this solution, an initial phoneme sequence corresponding to text is generated, the initial phoneme sequence comprising feature representations of a plurality of phonemes. A first phoneme sequence is generated by inserting a feature representation of an additional phoneme into the initial phoneme sequence, the additional phoneme being related to a characteristic of spontaneous speech. The duration of a phoneme among the plurality of phonemes and the additional phoneme is determined by using an expert model corresponding to the phoneme, and a second phoneme sequence is generated based on the first phoneme sequence. Spontaneous-style speech corresponding to the text is determined based on the second phoneme sequence. In this way, spontaneous-style speech with more varying rhythms can be generated based on spontaneous-style additional phonemes and multiple expert models.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 illustrates a block diagram of a computing device which can implement a plurality of implementations of the subject matter described herein;

FIG. 2 illustrates an architecture diagram of a system for text-based speech generation according to implementations of the subject matter described herein;

FIG. 3 illustrates a schematic view of the process of generating a second phoneme sequence by using a duration determining module according to the implementations of the subject matter described herein;

FIG. 4 illustrates a flowchart of a method for text-based speech generation according to the implementations of the subject matter described herein; and

FIG. 5 illustrates a flowchart of a method for training a model for text-based speech generation according to the implementations of the subject matter described herein.

Throughout the drawings, the same or similar reference signs refer to the same or similar elements.

### DETAILED DESCRIPTION

The subject matter described herein will now be discussed with reference to several example implementations. It is to be understood these implementations are discussed only for the purpose of enabling persons skilled in the art to better understand and thus implement the subject matter described herein, rather than suggesting any limitations on the scope of the subject matter.

As used herein, the term “includes” and its variants are to be read as open terms that mean “includes, but is not limited to.” The term “based on” is to be read as “based at least in part on.” The term “one implementation” and “an implementation” are to be read as “at least one implementation.” The term “another implementation” is to be read as “at least one other implementation.” The terms “first,” “second,” and the like may refer to different or same objects. Other definitions, explicit and implicit, may be included below.

As used herein, the term “neural network” can handle inputs and provide corresponding outputs and it usually includes an input layer, an output layer and one or more hidden layers between the input and output layers. The neural network used in the deep learning applications usually includes a plurality of hidden layers to extend the depth of the network. Individual layers of the neural network model are connected in sequence, such that an output of a preceding layer is provided as an input for a following layer, where the input layer receives the input of the neural network while the output of the output layer acts as the final output of the neural network. Each layer of the neural network includes one or more nodes (also referred to as processing nodes or neurons) and each node processes the input from the preceding layer. In the text, the terms “neural network,” “model,” “network” and “neural network model” may be used interchangeably.

As described above, there currently exists a gap between speech generated by the TTS solution and real human speech. For example, the generated speech is stiffer and less smooth than the real human speech. Conventional TTS solutions have proposed some methods to simulate pitch and volume changes in the real human speech so as to generate high-quality reading-style speech. However, in the generated speech pauses, repetitions, diverse rhythms and other characteristics of spontaneous speech are not well simulated. Therefore, there is still a need for a solution that can generate text-based spontaneous-style speech (also referred to as naturally-spoken speech). According to implementations of the subject matter described herein, a solution is proposed for text-based speech generation. In the solution, an initial phoneme sequence corresponding to text is generated, the initial phoneme sequence comprising feature representations of a plurality of phonemes. A first phoneme sequence is generated by inserting a feature representation of an additional phoneme into the initial phoneme sequence, the additional phoneme being related to a characteristic of spontaneous speech. By using an expert model corresponding to a phoneme among the plurality of phonemes and the additional phoneme, the duration of the phoneme is determined, and a second phoneme sequence is generated based on the first phoneme sequence. Spontaneous-style speech corresponding to the text is determined based on the second phoneme sequence. Detailed description is presented below to various example implementations of the solution in conjunction with the drawings.

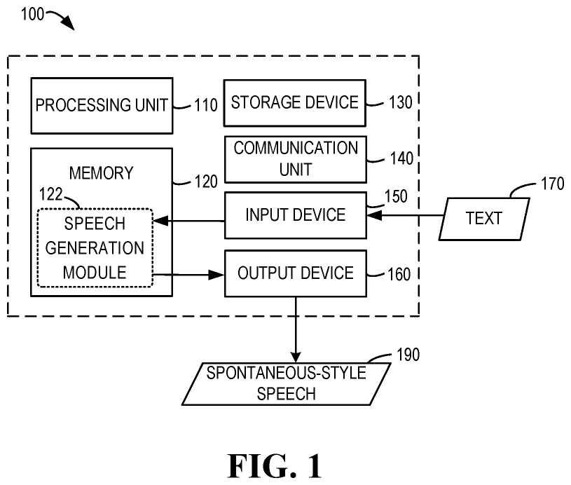

FIG. 1 illustrates a block diagram of a computing device 100 that can implement a plurality of implementations of the subject matter described herein. It should be understood that the computing device 100 shown in FIG. 1 is only exemplary and shall not constitute any limitation on the functions and scopes of the implementations described by the subject matter described herein. As shown in FIG. 1, the computing device 100 includes a computing device 100 in the form of a general purpose computing device. Components of the computing device 100 may include, but is not limited to, one or more processors or processing units 110, a memory 120, a storage device 130, one or more communication units 140, one or more input devices 150, and one or more output devices 160.

In some implementations, the computing device 100 may be implemented as various user terminals or service terminals with computing capability. The service terminals may be servers, large-scale computing devices, and the like provided by a variety of service providers. The user terminal, for example, is a mobile terminal, a fixed terminal or a portable terminal of any type, including a mobile phone, a site, a unit, a device, a multimedia computer, a multimedia tablet, Internet nodes, a communicator, a desktop computer, a laptop computer, a notebook computer, a netbook computer, a tablet computer, a Personal Communication System (PCS) device, a personal navigation device, a Personal Digital Assistant (PDA), an audio/video player, a digital camera/video, a positioning device, a television receiver, a radio broadcast receiver, an electronic book device, a gaming device or any other combination thereof consisting of accessories and peripherals of these devices or any other combination thereof. It may also be predicted that the computing device 100 can support any type of user-specific interface (such as a “wearable” circuit, and the like).

The processing unit 110 may be a physical or virtual processor and may execute various processing based on the programs stored in the memory 120. In a multi-processor system, a plurality of processing units executes computer-executable instructions in parallel to enhance parallel processing capability of the computing device 100. The processing unit 110 can also be known as a central processing unit (CPU), microprocessor, controller and microcontroller.

The computing device 100 usually includes a plurality of computer storage mediums. Such mediums may be any attainable medium accessible by the computing device 100, including but not limited to, a volatile and non-volatile medium, a removable and non-removable medium. The memory 120 may be a volatile memory (e.g., a register, a cache, a Random Access Memory (RAM)), a non-volatile memory (such as, a Read-Only Memory (ROM), an Electrically Erasable Programmable Read-Only Memory (EEPROM), flash), or any combination thereof. The memory 120 may include a speech generation module 122, which are configured to perform various functions described herein. The speech generation module 122 may be accessed and operated by the processing unit 110 to realize corresponding functions.

The storage device 130 may be a removable or non-removable medium, and may include a machine-readable medium (e.g., a memory, a flash drive, a magnetic disk) or any other medium, which may be used for storing information and/or data and be accessed within the computing device 100. The computing device 100 may further include additional removable/non-removable, volatile/non-volatile storage mediums. Although not shown in FIG. 1, there may be provided a disk drive for reading from or writing into a removable and non-volatile disk and an optical disc drive for reading from or writing into a removable and non-volatile optical disc. In such cases, each drive may be connected to a bus (not shown) via one or more data medium interfaces.

The communication unit 140 implements communication with another computing device via a communication medium. Additionally, functions of components of the computing device 100 may be realized by a single computing cluster or a plurality of computing machines, and these computing machines may communicate through communication connections. Therefore, the computing device 100 may operate in a networked environment using a logic connection to one or more other servers, a Personal Computer (PC) or a further general network node.

The input device 150 may be one or more various input devices, such as a mouse, a keyboard, a trackball, a voice-input device, and the like. The output device 160 may be one or more output devices, e.g., a display, a loudspeaker, a printer, and so on. The computing device 100 may also communicate through the communication unit 140 with one or more external devices (not shown) as required, where the external device, e.g., a storage device, a display device, and so on, communicates with one or more devices that enable users to interact with the computing device 100, or with any device (such as a network card, a modem, and the like) that enable the computing device 100 to communicate with one or more other computing devices. Such communication may be executed via an Input/Output (I/O) interface (not shown).

In some implementations, apart from being integrated on an individual device, some or all of the respective components of the computing device 100 may also be set in the form of a cloud computing architecture. In the cloud computing architecture, these components may be remotely arranged and may cooperate to implement the functions described by the subject matter described herein. In some implementations, the cloud computing provides computation, software, data access and storage services without informing a terminal user of physical locations or configurations of systems or hardware providing such services. In various implementations, the cloud computing provides services via a Wide Area Network (such as Internet) using a suitable protocol. For example, the cloud computing provider provides, via the Wide Area Network, the applications, which can be accessed through a web browser or any other computing component. Software or components of the cloud computing architecture and corresponding data may be stored on a server at a remote location. The computing resources in the cloud computing environment may be merged or spread at a remote datacenter. The cloud computing infrastructure may provide, via a shared datacenter, the services even though they are shown as a single access point for the user. Therefore, components and functions described herein can be provided using the cloud computing architecture from a service provider at a remote location. Alternatively, components and functions may also be provided from a conventional server, or they may be mounted on a client device directly or in other ways.

The computing device 100 may be used for implementing text-based speech generation according to various implementations of the subject matter described herein. As shown in FIG. 1, the computing device 100 may receive text 170 through the input device 150. The text 170 is used to generate needed speech. The text 170 may comprise multiple text sequences. The input device 150 may transmit the text 170 to the speech generation module 122. The speech generation module 122 generates corresponding spontaneous-style speech 190 according to the text 170. The spontaneous-style speech 190 has unique characteristics. As compared with reading-style speech, the spontaneous-style speech 190 may have more varying rhythms. The rhythm of speech may be characterized by the duration and pitch of the phoneme. The spontaneous-style speech 190 may comprise phonemes with more various durations. For example, the lengthening or shortening of specific phonemes occurs more often in spoken language.

The spontaneous-style speech 190 may have additional phonemes. Additional phonemes may be phonemes of speech that has no actual meanings and does not provide additional information. Examples of additional phonemes may include phonemes indicating pauses, phonemes indicating repetitions and phonemes indicating idioms. For example, pauses such as “um” and “uh” may occur in the spontaneous-style speech 190. In another example, after people say some specific words, they tend to repeat these words, in this case the spontaneous-style speech 190 may comprise phonemes indicating repetitions. In a further example, some people get used to say idioms such as “right” after specific words, in this case the spontaneous-style speech 190 may comprise phonemes indicating personal idioms.

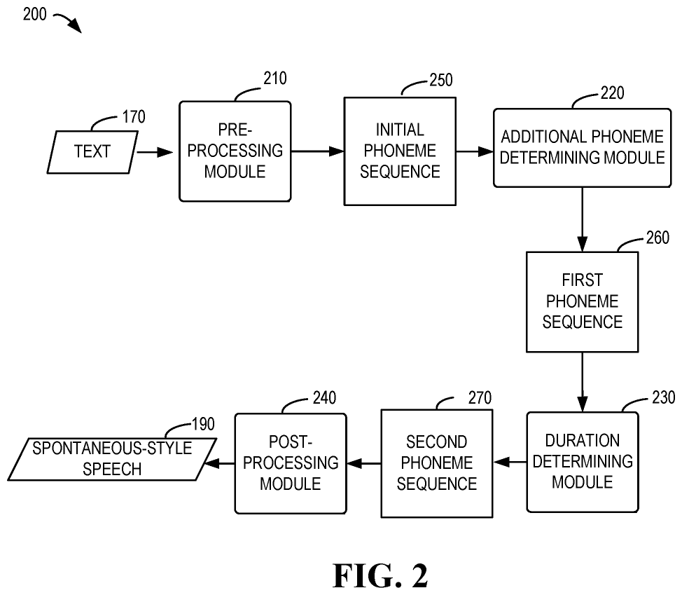

FIG. 2 shows an architecture diagram of a system 200 for text-based speech generation according to implementations of the subject matter described herein. The system 200 may be implemented in the computing device 100 of FIG. 1. The system 200 may be an end-to-end neural network model. As shown in FIG. 2, the system 200 may comprise a pre-processing module 210, an additional phoneme determining module 220, a duration determining module 230 and a post-processing module 240.

The pre-processing module 210 pre-processes the received text 170. The pre-processing module 210 may perform the grapheme-to-phoneme conversion on the text 170. The grapheme-to-phoneme conversion may convert English text “It's called um right uh apple” into corresponding phonemes “ih t s k ao l d ah m r ay t ah ae p ax l.” Various grapheme-to-phoneme conversion methods may be used to convert the text 170 into corresponding phonemes. The scope of the subject matter described herein is not limited with this regard.

The pre-processing module 210 may further encode phonemes resulting from the grapheme-to-phoneme conversion so as to generate an initial phoneme sequence 250 corresponding to the text 170. The initial phoneme sequence 250 comprises feature representations of a plurality of phonemes and each phoneme corresponds to a feature representation in the vector form. The initial phoneme sequence 250 may be initial feature representations used for representing the text 170. Based on the phonemes obtained from the conversion, various methods may be used to generate the initial phoneme sequence 250. The pre-processing module 210 may use an embedder to generate embeddings of phonemes in the vector-form. The embedder may use phoneme embedding algorithms to capture acoustic information (e.g., pronunciation features) in phonemes so as to generate embeddings of phonemes for representing the acoustic information. The pre-processing module 210 may further use an encoder to encode the embeddings of phonemes as feature representations of phonemes. The encoder may be a network consisting of attention layers and convolutional layers. The training of networks used for embedding and encoding phonemes will be described below. The scope of the subject matter described herein is not limited in regard of the methods of embedding and encoding phonemes.

The additional phoneme determining module 220 generates a first phoneme sequence 260 based on the initial phoneme sequence 250. By inserting a feature representation of an additional phoneme into the initial phoneme sequence 250, the additional phoneme determining module 220 generates the first phoneme sequence 260. In other words, the first phoneme sequence 260 not only comprises feature representations of a plurality of phonemes of the initial phoneme sequence 250 but also comprises the feature representation of the additional phoneme. As described above, the additional phoneme is related to a characteristic of spontaneous speech. For example, the additional phoneme may be related to pauses, repetitions or idioms.

In some implementations, the feature representation of the additional phoneme may be an embedding of the additional phoneme. Alternatively, the feature representation of the additional phoneme may be variations of the embedding of the additional phoneme. In other implementations, the feature representation of the additional phoneme may be determined by the additional phoneme determining module 220 based on the initial phoneme sequence 250.

The additional phoneme determining module 220 may determine, based on the initial phoneme sequence 250, an appropriate position for insertion of the additional phoneme in the initial phoneme sequence 250. In other words, the additional phoneme determining module 220 may determine which additional phoneme is to be inserted into where in the plurality of phonemes corresponding to the text 170, based on the initial phoneme sequence 250. For example, the additional phoneme determining module 220 may determine that phonemes indicating a pause “um” are to be inserted into the speech corresponding to the example “this is an apple” in the text 170, and the additional phoneme determining module 220 may determine that the pause “um” is to be inserted between “this is” and “an apple.” In another example, the additional phoneme determining module 220 may determine that phonemes indicating an idiom “right” is to be inserted into the speech corresponding to the example “this is an apple” in the text 170, and the additional phoneme determining module 220 may determine that the idiom “right” is to be inserted at the end of “this is an apple.”

The additional phoneme determining module 220 may be a network consisting of common neural network layers such as a convolutional layer, a linear layer and a normalization layer. In some implementations, the additional phoneme determining module 220 may comprise two 1D-convolutional layers with ReLU activation functions, a dropout layer, a normalization layer, a linear layer and a softmax layer. The softmax layer is used to predict the probabilities of the additional phoneme belonging to various categories. For example, categories of additional phonemes may comprise a category for no additional phoneme, a category for the pause “um,” a category for the pause “uh,” a category for the repetition of the last word, a category for the idiom “right,” etc. The training of the additional phoneme determining module 220 will be described in detail below. The scope of the subject matter described herein is not limited in regard of the construction and training of the additional phoneme determining module 220.

By inserting the feature representation of the additional phoneme into the initial phoneme sequence 250 appropriately to generate the first phoneme sequence 260, speech generated based on the text 170 may comprise additional phonemes related to spontaneous speech. In this way, the similarity between the generated speech and naturally-spoken speech may be increased, and the generated spontaneous-style speech 190 sounds more authentic.

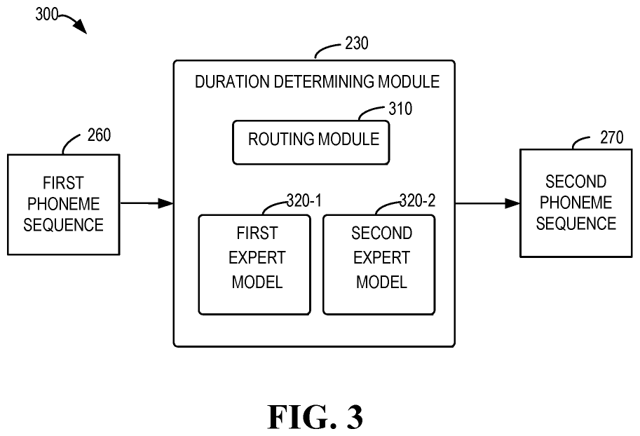

Based on the first phoneme sequence 260, the duration determining module 230 generates a second phoneme sequence 270 by determining the durations of phonemes in the first phoneme sequence 260. It should be understood that phonemes in the first phoneme sequence 260 comprise the inserted additional phonemes. The duration of the phoneme may take a unit of frames, and the length of each frame may be 10 ms, for example. With respect to each phoneme in the first phoneme sequence 260, the duration determining module 230 predicts the corresponding duration represented by the number of frames. Specifically, the duration determining module 230 determines the duration of a phoneme in the first phoneme sequence 260 by using an expert model corresponding to the phoneme. The duration determining module 230 may use mixture of experts (MOE) to determine the durations of the phonemes. Details of the duration determining module 230 will be described with reference to FIG. 3 below.

FIG. 3 shows a schematic view of generating the second phoneme sequence 270 by using the duration determining module 230 according to the implementations of the subject matter described herein. The duration determining module 230 may comprise a routing module (a routing module 310 as shown in FIG. 3) and multiple expert models. The routing module 310 may classify phonemes in the first phoneme sequence 260 into different categories. Categories may be related to the length of durations of phonemes. In some implementations, the routing module 310 may classify phonemes into two categories, i.e., a category for long durations and a category for short durations.

For a category of phonemes, a respective expert model among the multiple expert models that performs the best for the respective category of phonemes may be selected to predict the durations of the category of phonemes. The multiple expert models may comprise two, three or more expert models. The multiple expert models may comprise a first expert model 320-1 and a second expert model 320-2 as shown in FIG. 3. In some implementations, the first expert model 320-1 may be used to predict the durations of a category of phonemes with long durations, and the second expert model 320-2 may be used to predict the durations of a category of phonemes with short durations.

In some implementations, predictions of a same phoneme from multiple expert models may be considered comprehensively. As an example, when determining a category of a phoneme, the routing module 310 may determine the probabilities of the phoneme belonging to different categories. By using the probabilities for different categories as respective weights, the durations predicted by the multiple expert models may be summed up. The duration determining module 230 may determine the weighted sum of durations as the duration of the phoneme.

The duration determining module 230 further updates the first phoneme sequence 260 based on the determined duration of the phoneme, thereby generating the second phoneme sequence 270. In some implementations, the duration determining module 230 may update the first phoneme sequence 260 by expanding it based on the determined durations of the phonemes. In other words, feature representations of phonemes in the first phoneme sequence 260 may be arranged according to the corresponding durations. For example, if it is determined that the duration of a first phoneme in the first phoneme sequence 260 is 5 frames and the duration of a second phoneme is 2 frames, then the first phoneme sequence 260 may be updated to the second phoneme sequence 270 with the feature representation of the first phoneme repeating 5 times and the feature representation of the second phoneme repeating 2 times.

In some implementations, if the first phoneme sequence 260 is related to the initialized duration, then the duration determining module 230 may update the first phoneme sequence 260 by lengthening or shortening the duration of the phonemes in the first phoneme sequence 260. For example, if it is determined that the duration of the first phoneme in the first phoneme sequence 260 is 5 frames, the first phoneme sequence 260 may be updated to the second phoneme sequence 270 with the feature representation of the first phoneme repeating 5 times rather than repeating 3 times as in the first phoneme sequence 260.

The network structures of the routing module 310 and multiple expert models may be similar to that of the additional phoneme determining module 220. The training of the routing module 310 and multiple expert models may be described in detail below. The scope of the subject matter described herein is not limited in the regard of the model construction and training of the duration determining module 230.

By updating the first phoneme sequence 260 based on the durations of the phonemes, speech generated based on the text 170 may have rhythms with more varieties. In this way, the similarity between the generated speech and the real spoken language may be increased, and the generated spontaneous-style speech 190 sounds more authentic.

Referring back to FIG. 2, the post-processing module 240 may determine, based on the second phoneme sequence 270, the spontaneous-style speech 190 corresponding to the text 170. In some implementations, the post-processing module 240 may determine the pitches of the phonemes in the second phoneme sequence 270. The post-processing module 240 may update the second phoneme sequence 270 based on the determined pitches. Specifically, the post-processing module 240 may predict the pitch of the phoneme by using a network similar to that of the additional phoneme determining module 230. The predicted pitch may be converted into an embedding vector of the pitch. The embedding vector of the pitch may be added to the feature representation of the corresponding pitch, such that the second phoneme sequence 270 may be updated. The scope of the subject matter described herein is not limited in the regard of methods for the determination of pitches.

In some implementations, the post-processing module 240 may generate a third phoneme sequence (not shown) by updating the second phoneme sequence 270 based on voice characteristics of a target speaker. The voice characteristics of the target speaker may comprise the timbre. The post-processing module 240 may determine the spontaneous-style speech 190 corresponding to both of the text 170 and the target speaker, based on the third phoneme sequence. Specifically, the post-processing module 240 may updating the second phoneme sequence 270 by adding an embedding vector that indicates the voice characteristics of the target speaker to the feature representation of the corresponding phoneme. The scope of the subject matter described herein is not limited in the regard of methods for the determination of the embedding vector that indicates the voice characteristics of the target speaker.

In some implementations, the post-processing module 240 may use a decoder to generate a mel-spectrogram corresponding to the text 170 based on the second phoneme sequence 270. Then the mel-spectrogram may be converted into speech, i.e., the spontaneous-style speech 190. The decoder may be any appropriate network, and the scope of the subject matter described herein is not limited in this regard.

It should be understood that the structure and functionality of the system 200 have been described only for the illustration purpose, rather than suggesting any limitation on the scope of the subject matter described herein. In fact, the subject matter described herein may be embodied in different structure and/or functionality.

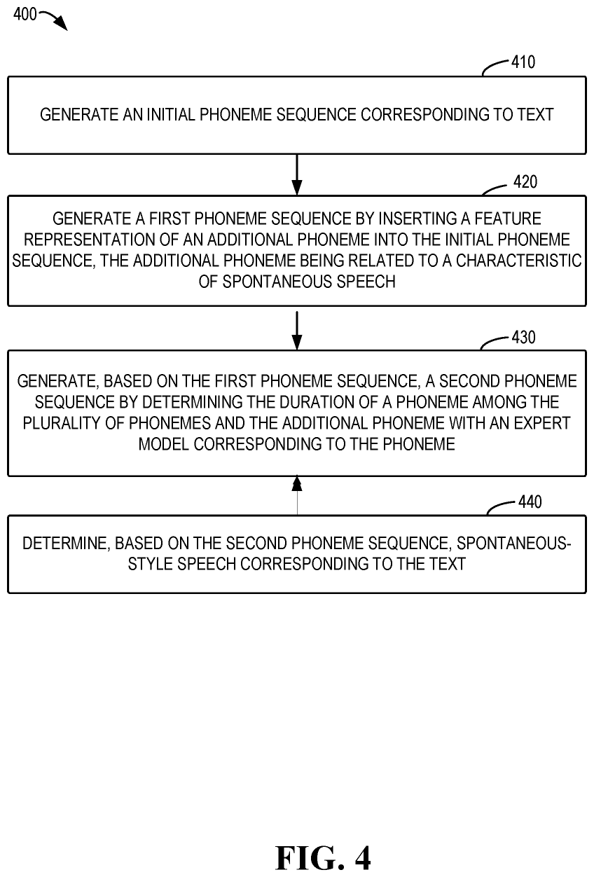

FIG. 4 shows a flowchart of a method 400 for text-based speech generation according to some implementations of the subject matter described herein. The method 400 may be implemented by the computing device 100, e.g., may be implemented at the speech generation module 122 in the memory 120 of the computing device 100.

As shown in FIG. 4, at block 410, the computing device 100 generates an initial phoneme sequence 250 corresponding to text 170, the initial phoneme sequence 250 comprising feature representations of a plurality of phonemes. At block 420, the computing device 100 generates a first phoneme sequence 260 by inserting a feature representation of an additional phoneme into the initial phoneme sequence 250, the additional phoneme being related to characteristics of spontaneous speech. In some implementations, the additional phoneme comprises at least one of: a phoneme indicating a pause; a phoneme indicating a repetition; and a phoneme indicating an idiom.

At block 430, the computing device 100 generates a second phoneme sequence 270 based on the first phoneme sequence 260 by using an expert model corresponding to a respective phoneme among the plurality of phonemes and the additional phoneme to determine the duration of the respective phoneme. In some implementations, generating the second phoneme sequence 270 based on the first phoneme sequence 260 comprises: determining a category of the phoneme among the plurality of phonemes and the additional phoneme; and predicting the duration of the phoneme by using an expert model that corresponds to the category among the multiple expert models.

At block 440, the computing device 100 determines spontaneous-style speech 190 corresponding to the text 170 based on the second phoneme sequence 270. In some implementations, determining the spontaneous-style speech 190 corresponding to the text 170 based on the second phoneme sequence 270 comprises: generating a third phoneme sequence by updating the second phoneme sequence 270 based on a voice characteristic of a target speaker; and determining the spontaneous-style speech 190 corresponding to both of the text 170 and the target speaker based on the third phoneme sequence.

In this way, based on the additional phonemes related to characteristics of spontaneous speech and phonemes with more various durations, the similarity between the generated speech and the naturally-spoken speech may be increased, and the generated spontaneous-style speech 190 sounds more authentic.

Working principles of the method for text-based speech generation according to the implementations of the subject matter described herein have been described in detail with reference to FIGS. 1 to 4. Now, the process of training the end-to-end neural network model used in this method will be described below.

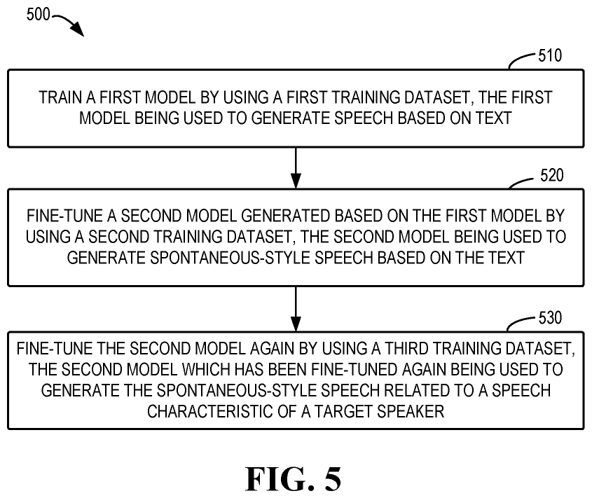

FIG. 5 shows a flowchart of a method 500 for training a model for text-based speech generation according to some implementations of the subject matter described herein. The method 500 may be implemented by the computing device 100, e.g., may be implemented at the speech generation module 122 in the memory 120 of the computing device 100.

As shown in FIG. 5, at block 510, the computing device 100 trains a first model by using a first training dataset, the first model being used to generate speech based on text. The first model may generate based on the text 170 speech corresponding to text 170. The first model may be any appropriate TTS model. The first model may be a multi-speaker TTS model. The first model may comprise modules similar to the pre-processing model 210 and the post-processing module 240 shown in FIG. 2. The first model may further comprise a rhythm determining module for predicting the duration and pitch of a phoneme.

The first training dataset may be an appropriate dataset for speech synthesis. In some implementations, the first training dataset may comprise text and corresponding speech. An audio transcription method may be used to obtain corresponding text based on raw speech. The text and raw speech may be aligned in time. In some implementations, the text may be converted into a sequence of corresponding phonemes. The first training dataset may comprise the sequence of phonemes and the corresponding raw speech. The first training dataset may further comprise the duration of each phoneme. The first training dataset may further comprise the pitch of each phoneme extracted from the raw speech. When the first model is a multi-speaker TTS model, the first training dataset may further comprise raw speech from multiple speakers and identifications of speakers.

At block 520, the computing device 100 fine-tunes a second model generated based on the first model by using a second training dataset, the second model being used to generate spontaneous-style speech based on text. The second model may be used to generate the spontaneous-style speech 190 based on the text 170 as shown in FIG. 2. The second model may comprise the pre-processing model 210, the additional phoneme determining module 220, the duration determining module 230, the post-processing module 240 as shown in FIG. 2 or other similar modules. Alternatively or additionally, the second model may also comprise any other appropriate module for generating spontaneous-style speech.

The second training dataset may be any appropriate dataset for spontaneous-style speech synthesis. The second training dataset may be built from raw speech in spontaneous style. The second training dataset is smaller than the first training dataset. In other words, the second training dataset may be built from less speech data. A method similar to the above mentioned method for determining the first training dataset may be used to determine the corresponding text and the sequence of phonemes based on the raw speech in spontaneous style. Based on the raw speech in spontaneous style and the determined text and sequence of phonemes, the second training dataset may be built for specific modules in the second model.

In some implementations, the second model may be generated by adding the additional phoneme determining module 220 to the first model. As described with reference to FIG. 2, the additional phoneme determining module 220 is used to determine the additional phoneme which is related to a characteristic of spontaneous speech among the plurality of phonemes corresponding to the spontaneous-style speech. The additional phoneme may be a phoneme indicating a pause, a phoneme indicating a repetition, and a phoneme indicating an idiom. In this case, the second training dataset may be built for specifically training the additional phoneme determining module 220. The additional phonemes may be identified from the sequence of phonemes determined from the raw speech in spontaneous style. A corresponding label may be assigned to a phoneme among the sequence of phonemes that is followed by an additional phoneme. The label may indicate that the phoneme is not followed by an additional phoneme. The label may indicate the category of an additional phoneme. For example, the label may indicate that the phoneme is followed by no additional phoneme, an additional phoneme indicating a pause “um,” a pause “uh,” a repetition of the last word, or an idiom “right,” etc. A sequence of pure phonemes may be generated by removing the additional phoneme from the sequence of original phonemes. Each phoneme of the sequence of pure phonemes is assigned a label for indicating whether it is followed by an additional phoneme and/or the category of the additional phoneme. The sequence of pure phonemes with labels may be used as the second training dataset for fine-tuning the second model including the additional phoneme determining module 220. In other words, a part of parameters of the trained first model may be accepted as corresponding parameters of the second model. With these parameters kept unchanged, the second training dataset may be used to train parameters in the additional phoneme determining module 220. As described with reference to FIG. 2, the additional phoneme determining module 220 may receive the initial phoneme sequence 250 as an input and the initial phoneme sequence 250 may be generated by the embedder and the encoder based on grapheme-to-phoneme conversion. Therefore, while training the additional phoneme determining module 220, parameters of the trained embedder and encoder may be kept unchanged, and only parameters in the additional phoneme determining module 220 are trained.

In some implementations, the loss function for training the additional phoneme determining module 220 may be defined as follows:

$$L = - {y}_{0} log {s}_{0} - σ {\sum }_{i = 1}^{2} {y}_{i} log {s}_{i} \qquad ( 1 )$$

Wherein [s₀, s₁, s₂] denotes the probability of the phoneme belonging to three specific categories of additional phonemes, s0 for no additional phonemes, s1 for the additional phoneme “um,” s2 for the additional phoneme “uh”, [y₀, y₁, y₂] denotes the one-hot encoding of the ground-truth label, and σ denotes an adjustable parameter for adjusting the intensity of additional phonemes.

In some implementations, the second model may be generated by adding the duration determining module 230 to the first model. Alternatively, the second model may be generated by modifying a module for determining duration in the first model to be the duration determining module 230 as shown in FIG. 2. In this case, the second training dataset may be built for specifically training the duration determining module 230. For example, the durations of the sequence of phonemes may be determined from raw speech with an alignment tool. Details of the alignment tool are not described here.

The sequence of phonemes labelled with ground-truth durations may be used as the second training dataset for fine-tuning the second model including the duration determining module 230. Similarly, a part of parameters of the trained first model may be accepted as corresponding parameters of the second model. With these parameters kept unchanged, the second training dataset may be used to train parameters in the duration determining module 230. For example, parameters of the trained embedder and encoder may be kept unchanged, and only parameters in the duration determining module 230 are trained.

Specifically, the duration determining module 230 may be trained using a sequence of phonemes labelled with real durations. In some implementations, categories of the real durations may be determined based on the length of the durations. The routing module 310 in the duration determining module 230 may be trained using the sequence of phonemes labelled with the categories of the real durations. As described above, the routing module 310 may classify a phoneme into a respective category and determine an expert model corresponding to the phoneme among multiple expert models. In some implementations, parameters of each expert model may be initialized by the module for determining durations in the trained first model.

In some implementations, the training of the additional phoneme determining module 220 and the duration determining module 230 in the second model may take place in stages. Specifically, parameters of the additional phoneme determining module 220 may be determined first by using the training dataset for the additional phoneme determining module 220. The parameters of the additional phoneme determining module 230 may be inherited and based on that, the parameters of the duration determining module 230 may be determined by using the training dataset for the duration determining module 230.

In this way, by inheriting a part of parameters of the trained first model, less spontaneous-style speech data are needed for fine-tuning the second model and thus the training efficiency can be increased.

At block 530, the computing device 100 fine-tunes the second model a second time by using a third training dataset, the second model which has been fine-tuned again being used to generate spontaneous-style speech related to a voice characteristic of a target speaker. The third training dataset may be built from raw speech of the target speaker. The third training dataset is smaller than the first and second training dataset. The third training dataset may be built from the raw speech and a sequence of phonemes corresponding to the raw speech. Note that the third training dataset may be built from non-spontaneous-style speech data.

By using the third training dataset, the second model may be fine-tuned a second time to learn the voice characteristic of the target speaker, e.g., the timbre of the target speaker. Similarly, a part of parameters of the fine-tuned second model may be kept unchanged, and the third training dataset may be used to specifically train a module for the voice characteristic of the target speaker in the second model. For example, parameters of the trained embedder, encoder, additional phoneme determining module 220 and duration determining module 230 may be kept unchanged. Only parameters of a layer for learning the voice characteristic of the target speaker in the post-training module 240 may be trained. For example, only parameters of a conditional layer normalization layer are trained.

In this way, by inheriting a part of parameters of the fine-tuned second model, less speech data of the target speaker are needed for fine-tuning the second model a second time and thus the training efficiency may be increased. The second model which has been fine-tuned a second time may generate the spontaneous-style speech 190 that conforms to the speech characteristic of the target speaker, based on the text 170.

It should be understood that the policy for training the speech synthesis model in stages according to the implementations of the subject matter described herein may be further applicable to other scenarios. For example, on the basis of the trained first model, the second training dataset for speech in different natural speaking styles may be used to fine-tune the second model generated based on the first model. Examples of speech in different natural speaking styles may comprise whisper-style speech, presentation-style speech, etc. In this way, the need for training data of specific spontaneous-style speech may be reduced, and the training efficiency can be increased.

Some example implementations of the subject matter described herein are listed below.

In a first aspect, the subject matter described herein provides a computer-implemented method. The method comprises: generating an initial phoneme sequence corresponding to text, the initial phoneme sequence comprising feature representations of a plurality of phonemes; generating a first phoneme sequence by inserting a feature representation of an additional phoneme into the initial phoneme sequence, the additional phoneme being related to a characteristic of spontaneous speech; generating, based on the first phoneme sequence, a second phoneme sequence by determining the duration of a phoneme among the plurality of phonemes and the additional phoneme with an expert model corresponding to the phoneme; and determining, based on the second phoneme sequence, spontaneous-style speech corresponding to the text.

In some implementations, the additional phoneme comprises at least one of: a phoneme indicating a pause; a phoneme indicating a repetition; and a phoneme indicating an idiom.

In some implementations, generating the second phoneme sequence 270 based on the first phoneme sequence 260 comprises: determining a category of the phoneme among the plurality of phonemes and the additional phoneme; and predicting the duration of the phoneme by using an expert model of multiple expert models that corresponds to the category.

In some implementations, determining the spontaneous-style speech 190 corresponding to the text 170 based on the second phoneme sequence 270 comprises: generating a third phoneme sequence by updating the second phoneme sequence based on a speech characteristic of a target speaker; and determining, based on the third phoneme sequence, the spontaneous-style speech corresponding to both of the text and the target speaker.

In a second aspect, the subject matter described herein provides an electronic device. The electronic device comprises: a processing unit; and a memory coupled to the processing unit and comprising instructions stored thereon which, when executed by the processing unit, cause the device to perform acts comprising: generating an initial phoneme sequence corresponding to text, the initial phoneme sequence comprising feature representations of a plurality of phonemes; generating a first phoneme sequence by inserting a feature representation of an additional phoneme into the initial phoneme sequence, the additional phoneme being related to a characteristic of spontaneous speech; generating, based on the first phoneme sequence, a second phoneme sequence by determining the duration of a phoneme among the plurality of phonemes and the additional phoneme with an expert model corresponding to the phoneme; and determining, based on the second phoneme sequence, spontaneous-style speech corresponding to the text.

In some implementations, the additional phoneme comprises at least one of: a phoneme indicating a pause; a phoneme indicating a repetition; and a phoneme indicating an idiom.

In some implementations, generating the second phoneme sequence 270 based on the first phoneme sequence 260 comprises: determining a category of the phoneme among the plurality of phonemes and the additional phoneme; and predicting the duration of the phoneme by using an expert model of multiple expert models that corresponds to the category.

In some implementations, determining the spontaneous-style speech 190 corresponding to the text 170 based on the second phoneme sequence 270 comprises: generating a third phoneme sequence by updating the second phoneme sequence based on a speech characteristic of a target speaker; and determining, based on the third phoneme sequence, the spontaneous-style speech corresponding to both of the text and the target speaker.

In a further aspect, the subject matter described herein provides a computer program product being tangibly stored in a non-transitory computer storage medium and comprising machine-executable instructions which, when executed by a device, causing the device to perform the method of the above aspect.

In a third aspect, the subject matter described herein provides a computer program product including machine-executable instructions which, when executed by a device, cause the device to perform the method of the first aspect.

In a fourth aspect, the subject matter described herein provides a computer-readable medium having machine-executable instructions stored thereon which, when executed by a device, cause the device to perform the method of the second aspect.

In a fifth aspect, the subject matter described herein provides a computer-implemented method. The method comprises: training a first model by using a first training dataset, the first model being used to generate speech based on text; fine-tuning a second model generated based on the first model by using a second training dataset, the second model being used to generate spontaneous-style speech based on the text; and fine-tuning the second model again by using a third training dataset, the second model which has been fine-tuned again being used to generate the spontaneous-style speech related to a speech characteristic of a target speaker; wherein the first training dataset, the second training dataset and the third training dataset decrease in size in this order.

In some implementations, the additional phoneme comprises at least one of: a phoneme indicating a pause; a phoneme indicating a repetition; and a phoneme indicating an idiom.

In some implementations, fine-tuning the second model generated based on the first model by using the second training dataset comprises: generating the second model by adding an additional phoneme determining module into the first model, the additional phoneme determining module being used to determine an additional phoneme among a plurality of phonemes corresponding to the spontaneous-style speech, the additional phoneme being related to a characteristic of spontaneous speech; and training the additional phoneme determining module by using the second training dataset.

In some implementations, fine-tuning the second model generated based on the first model by using the second training dataset comprises: training a duration determining module in the second model by using the second training dataset, the duration determining module being used to determine durations of a plurality of phonemes corresponding to the spontaneous-style speech.

In some implementations, determining durations of the plurality of phonemes corresponding to the spontaneous-style speech comprises: determining an expert model of multiple expert models that corresponds to a phoneme of the plurality of phonemes; and determining the duration of the phoneme by using the expert model.

In a sixth aspect, the subject matter described herein provides an electronic device. The electronic device comprises: a processing unit; and a memory coupled to the processing unit and comprising instructions stored thereon which, when executed by the processing unit, cause the device to perform acts comprising: training a first model by using a first training dataset, the first model being used to generate speech based on text; fine-tuning a second model generated based on the first model by using a second training dataset, the second model being used to generate spontaneous-style speech based on the text; and fine-tuning the second model again by using a third training dataset, the second model which has been fine-tuned again being used to generate the spontaneous-style speech related to a speech characteristic of a target speaker; wherein the first training dataset, the second training dataset and the third training dataset decrease in size in this order.

In some implementations, the additional phoneme comprises at least one of: a phoneme indicating a pause; a phoneme indicating a repetition; and a phoneme indicating an idiom.

In some implementations, fine-tuning the second model generated based on the first model by using the second training dataset comprises: generating the second model by adding an additional phoneme determining module into the first model, the additional phoneme determining module being used to determine an additional phoneme among a plurality of phonemes corresponding to the spontaneous-style speech, the additional phoneme being related to a characteristic of spontaneous speech; and training the additional phoneme determining module by using the second training dataset.

In some implementations, fine-tuning the second model generated based on the first model by using the second training dataset comprises: training a duration determining module in the second model by using the second training dataset, the duration determining module being used to determine durations of a plurality of phonemes corresponding to the spontaneous-style speech.

In some implementations, determining durations of the plurality of phonemes corresponding to the spontaneous-style speech comprises: determining an expert model of multiple expert models that corresponds to a phoneme of the plurality of phonemes; and determining the duration of the phoneme by using the expert model.

In a seventh aspect, the subject matter described herein provides a computer program product including machine-executable instructions which, when executed by a device, cause the device to perform the method of the fifth aspect.

In an eighth aspect, the subject matter described herein provides a computer-readable medium having machine-executable instructions stored thereon which, when executed by a device, cause the device to perform the method of the fifth aspect.

The functionality described herein can be performed, at least in part, by one or more hardware logic components. For example, and without limitation, illustrative types of hardware logic components that can be used include Field-Programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

Program code for carrying out methods of the subject matter described herein may be written in any combination of one or more programming languages. These program codes may be provided to a processor or controller of a general purpose computer, a special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or a server.

In the context of this subject matter described herein, a machine-readable medium may be any tangible medium that may contain, or store a program for use by or in connection with an instruction execution system, apparatus, or device. The machine-readable medium may be a machine-readable signal medium or a machine-readable storage medium. A machine-readable medium may include, but is not limited to, an electronic, magnetic, optical, electromagnetic, infrared, or semiconductor system, apparatus, or device, or any suitable combination of the foregoing. More specific examples of the machine-readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, although operations are depicted in a particular order, it should be understood that the operations are required to be executed in the particular order shown or in a sequential order, or all operations shown are required to be executed to achieve the expected results. In certain circumstances, multitasking and parallel processing may be advantageous. Likewise, while several specific implementation details are contained in the above discussions, these should not be construed as limitations on the scope of the subject matter described herein. Certain features that are described in the context of separate implementations may also be implemented in combination in a single implementation. Conversely, various features that are described in the context of a single implementation may also be implemented in multiple implementations separately or in any suitable sub-combination.

Although the subject matter has been described in language specific to structural features and/or methodological acts, it is to be understood that the subject matter specified in the appended claims is not necessarily limited to the specific features or acts described above. Rather, the specific features and acts described above are disclosed as example forms of implementing the claims.

1. A computer-implemented method, comprising:
generating an initial phoneme sequence corresponding to text, the initial phoneme sequence comprising feature representations of a plurality of phonemes;
generating a first phoneme sequence by inserting a feature representation of an additional phoneme into the initial phoneme sequence, the additional phoneme being related to a characteristic of spontaneous speech;
generating, based on the first phoneme sequence, a second phoneme sequence by determining the duration of a phoneme among the plurality of phonemes and the additional phoneme with an expert model corresponding to the phoneme; and
determining, based on the second phoneme sequence, spontaneous-style speech corresponding to the text.

2. The method of claim 1, wherein generating the second phoneme sequence based on the first phoneme sequence comprises:
determining a category of the phoneme among the plurality of phonemes and the additional phoneme; and
predicting the duration of the phoneme by using an expert model of multiple expert models that corresponds to the category.

3. The method of claim 1, wherein determining the spontaneous-style speech corresponding to the text based on the second phoneme sequence comprises:
generating a third phoneme sequence by updating the second phoneme sequence based on a speech characteristic of a target speaker; and
determining, based on the third phoneme sequence, the spontaneous-style speech corresponding to both of the text and the target speaker.

4. The method of claim 1, wherein the additional phoneme comprises at least one of:
a phoneme indicating a pause;
a phoneme indicating a repetition; and
a phoneme indicating an idiom.

5. A computer-implemented method, comprising:
training a first model by using a first training dataset, the first model being used to generate speech based on text;
fine-tuning a second model generated based on the first model by using a second training dataset, the second model being used to generate spontaneous-style speech based on the text; and
fine-tuning the second model again by using a third training dataset, the second model which has been fine-tuned again being used to generate the spontaneous-style speech related to a speech characteristic of a target speaker;
wherein the first training dataset, the second training dataset and the third training dataset decrease in size in this order.

6. The method of claim 5, wherein fine-tuning the second model generated based on the first model by using the second training dataset comprises:
generating the second model by adding an additional phoneme determining module into the first model, the additional phoneme determining module being used to determine an additional phoneme among a plurality of phonemes corresponding to the spontaneous-style speech, the additional phoneme being related to a characteristic of spontaneous speech; and
training the additional phoneme determining module by using the second training dataset.

7. The method of claim 6, wherein the additional phoneme comprises at least one of:
a phoneme indicating a pause;
a phoneme indicating a repetition; and
a phoneme indicating an idiom.

8. The method of claim 5, wherein fine-tuning the second model generated based on the first model by using the second training dataset comprises:
training a duration determining module in the second model by using the second training dataset, the duration determining module being used to determine durations of a plurality of phonemes corresponding to the spontaneous-style speech.

9. The method of claim 8, wherein determining durations of the plurality of phonemes corresponding to the spontaneous-style speech comprises:
determining an expert model of multiple expert models that corresponds to a phoneme of the plurality of phonemes; and
determining the duration of the phoneme by using the expert model.

10. An electronic device, comprising:
a processing unit; and
a memory coupled to the processing unit and comprising instructions stored thereon which, when executed by the processing unit, cause the device to perform acts comprising:
generating an initial phoneme sequence corresponding to text, the initial phoneme sequence comprising feature representations of a plurality of phonemes;
generating a first phoneme sequence by inserting a feature representation of an additional phoneme into the initial phoneme sequence, the additional phoneme being related to a characteristic of spontaneous speech;
generating, based on the first phoneme sequence, a second phoneme sequence by determining the duration of a phoneme among the plurality of phonemes and the additional phoneme with an expert model corresponding to the phoneme; and
determining, based on the second phoneme sequence, spontaneous-style speech corresponding to the text.

11. The device of claim 10, wherein generating the second phoneme sequence based on the first phoneme sequence comprises:
determining a category of the phoneme among the plurality of phonemes and the additional phoneme; and
predicting the duration of the phoneme by using an expert model of multiple expert models that corresponds to the category.

12.-15. (canceled)
